(19) United States
(12) Patent Application Publication
(10) Pub. No.: US 2006/0245184 A1
(43) Pub. Date: Nov. 2, 2006

(54) IRIS DIFFUSER FOR ADJUSTING LIGHT BEAM PROPERTIES

(76) Inventor: Robert D. Galli, North Kingstown, RI (US)

Correspondence Address: BARLOW, JOSEPHS & HOLMES, LTD., 101 DYER STREET, 5TH FLOOR, PROVIDENCE, RI, 02903, US

(21) Appl. No.: 11/379,238

(22) Filed: Apr. 19, 2006

Related U.S. Application Data
(60) Provisional application No. 60/675,990, filed on Apr. 29, 2005.

(51) Int. Cl. F21L 4/00

(52) U.S. Cl. 362/208

(57) ABSTRACT

An apeture mechanism that utilizes translucent, transparent or colored blades to modify the output beam of a lighting device is provided. A conventional apeture mechanism having replacement blades formed of a diffusion screen provides a control assembly that, when placed in front of the output beam of a lighting device, allows the user to selectively control the beam between a spot and a flood pattern. Further, the blades may be formed of translucent or transparent colored filter material to alter the color of the output beam. The apeture mechanism may be incorporated into compact lighting devices such as flashlights, architectural lighting devices or other accessories for use in conjunction with these lighting devices.

### CROSS-REFERENCE TO RELATED APPLICATIONS

This application is related to and claims priority from earlier filed U.S. Provisional Patent Application No. 60/675,990, filed Apr. 29, 2005, the contents of which are incorporated herein by reference.

### BACKGROUND OF THE INVENTION

The present invention relates to a new assembly for adjusting and controlling the properties of a beam of light. More specifically, the present invention relates to an adjustable iris structure for use in conjunction with a lighting assembly, such as commercial and residential lighting fixtures, flashlights or miniature flashlights to control the characteristics of the output light beam.

Typically, an aperture mechanism, such as disclosed within the scope of the present invention, serves the purpose of controlling and setting the desired size of an aperture through which light passes. The aperture mechanism creates a sharp edged beam cutoff thereby limiting the light that can pass through the opening provided therein. In this context, such an aperture has an outer structure that supports a plurality of movable aperture blades, the inner edges of which in turn cooperate to define an inner aperture diameter. In order to actuate the aperture blades, the outer structure of the aperture mechanism is generally formed to include two coaxial disks facing with each other such that the aperture blades are interposed therebetween. The first disk pivotably supports each of the aperture blades at one end. The second disk is a cam disk having cam grooves for displacing the opposite ends of each of the aperture blades. Each aperture blade is provided with a pin that engages a respective cam groove on the second disk. By rotating the first disk with respect to the second disk, the blades are moved in a manner that closes or opens the aperture. As can be appreciated in the art, in order for the aperture blades to function in a manner that controls the size of the aperture and limit the amount of light passing therethrough, the blades must be formed from a fully opaque material. Often in the prior art, the blades are formed from a spring steel or black colored plastic.

This type of iris aperture control is also often utilized in conjunction with lighting devices where the need exists to control the diameter of a high intensity light beam. As an example, a theatrical spotlight generally includes such an iris aperture control to regulate the size of the beam that is projected onto the performance stage. In such an application, as was discussed above, the aperture blades are opaque and serve to regulate the size of the light beam while maintaining a sharp edged beam image in the far field of the lighting device. Similarly, such aperture mechanism assemblies are well known in the camera art for controlling the amount of light that enters the camera and reaches the film or light sensing plate.

While such an aperture control is well suited for regulating the overall beam size or volume of light that passes through the aperture opening, these devices do not provide any additional control over the properties of the light beam. Often, for example, in addition to controlling the size of the beam, a user may desire the ability to control the effective zoom of the light beam. For example, a user may desire a tight high intensity beam for illuminating objects that appear at a distance or a diffuse lower intensity beam that can be utilized to illuminate a broad field of illumination in close proximity to the user.

Most often, the prior art devices that provide a user with the ability to control the relative zoom of the light output beam of the device accomplished the control through the displacement of a reflector or an optical lens relative to the light source. In this manner the position of the light output source was adjusted relative to the optical center of the reflector thereby causing changes in the focus of the captured light output. As a result, there are numerous additional parts that must be included in the lighting device. Further, this displacement type control frequently results in the light and optical control (lens or reflector) being positioned in less than optimal relation to one another. This result is unacceptable for highly tuned or high precision lighting applications.

Therefore, there is a need for a lighting device that produces a smooth, evenly distributed beam of light in the far field of the beam while maintaining the optimal relationship between the light source and the optical control device and providing the user with the ability to control the output beam properties. In addition, there is a need for a lighting device that provides a high intensity beam of light that has a homogeneous illumination pattern that has a well-defined far field beam image and further provides the user an ability to tailor the light output pattern from the device.

### SUMMARY OF THE INVENTION

The present invention provides a novel aperture mechanism for use in conjunction with a lighting device in order to control the light output from the light source. Generally, the aperture mechanism of the present invention is suited for use in connection with a variety of lighting devices that incorporate any variety of light sources such as incandescent, compact fluorescent, xenon, halogen, high intensity discharge (HID), and high brightness light emitting diodes (LEDs). While the novel assembly of the present invention is generally described and illustrated in the context of a flashlight device, one skilled in the art can appreciate that the teachings of the present invention are equally functional and applicable in any other lighting environment as well. Accordingly, while a flashlight is shown, the present invention is intended to be applicable to other lighting devices such as interior and exterior architectural lighting, theatrical lighting, medical lighting as well as any other application wherein the need arises to control a light beam.

Accordingly, in one embodiment, the present invention is illustrated in the context of a flashlight device. The aperture mechanism assembly of the present invention is constructed to operate in the same fashion as the iris type aperture control disclosed above, having a movable support structure with a plurality of aperture blades retained therein. Actuation of the device causes the blades to open or close thereby controlling the size of the aperture formed by the blades. However, in the present invention the aperture blades are formed from a neutral density filter material, a translucent diffuser material or a colored filter material as will be described in detail below. When the actuator ring is rotated such that the aperture blades are in the fully open position, the lighting device functions normally, meaning that there is no change in the output beam characteristics. Alternately, when the actuator is rotated so that the aperture blades are in the fully closed position, (blades positioned across the output beam) the entire output beam passes through the blades of the aperture device thereby changing the beam output based on the characteristics of the medium from which the blades are constructed. For example, if the blades are formed from a diffusion screen that includes a uniform 40° diffusion pattern, the output beam will have a beam distribution that was distributed over a 40° wider pattern than the original output beam. Similarly, if the blades of the aperture device were formed using a colored filter, the output beam would be the color of the colored filter.

In another embodiment, the aperture mechanism assembly of the present invention may be incorporated into an architectural lighting device, thereby making the light tunable based on the feature that it is lighting. The aperture mechanism allows the lighting device to be variably adjusted between a spot and a flood beam pattern based on the desired lighting effect. Further, the color of the lighting device may be changed by simply opening or closing one of a series of different iris devices that are provided in front of the light source.

In yet another embodiment of the present invention, one or more iris diaphragms may be arranged at the base of a light tube accessory such as the wands used by law enforcement for directing traffic. The light tube accessory is then placed in front of a flashlight wherein the flashlight illuminates the tube causing it to glow. By providing a series of colored iris diaphragms, as disclosed in the present invention, between the light tube and the light output from the flashlight, a user can quickly change the output color of the light tube by opening or closing the desired iris diaphragm.

It is therefore an object of the present invention to provide a novel aperture mechanism construction that allows a user to selectively control and adjust the pattern of a light beam that is directed therethrough. It is a further object of the present invention to provide a novel aperture mechanism that incorporates an adjustable diffusion screen pattern thereby allowing a user to selectively adjust a light beam between a spot and a flood style output. It is yet a further object of the present invention to provide an aperture mechanism device that allows a user to selectively change the color of a light beam that is directed therethrough. It is still a further object of the present invention to provide a lighting assembly that incorporates an aperture mechanism that allows a user control over the output beam pattern and output beam color of the device.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a front perspective view of the aperture mechanism of the present invention in a substantially open position;

FIG. 2 is a front perspective view of the aperture mechanism of FIG. 1 in a substantially closed position;

FIG. 3 is a perspective view of a flashlight incorporating the aperture mechanism of the present invention;

FIG. 4 is a perspective view of an architectural lighting fixture incorporating the aperture mechanism of the present invention;

FIG. 5 is a perspective view of a light tube incorporating a plurality of aperture mechanisms of the present invention;

FIG. 6 is a cross sectional view taken along the line 6-6 of FIG. 3 showing the aperture mechanism in a substantially open position; and

FIG. 6a is a cross sectional view taken along the line 6-6 of FIG. 3 showing the aperture mechanism in a substantially closed position.

### DETAILED DESCRIPTION OF THE INVENTION

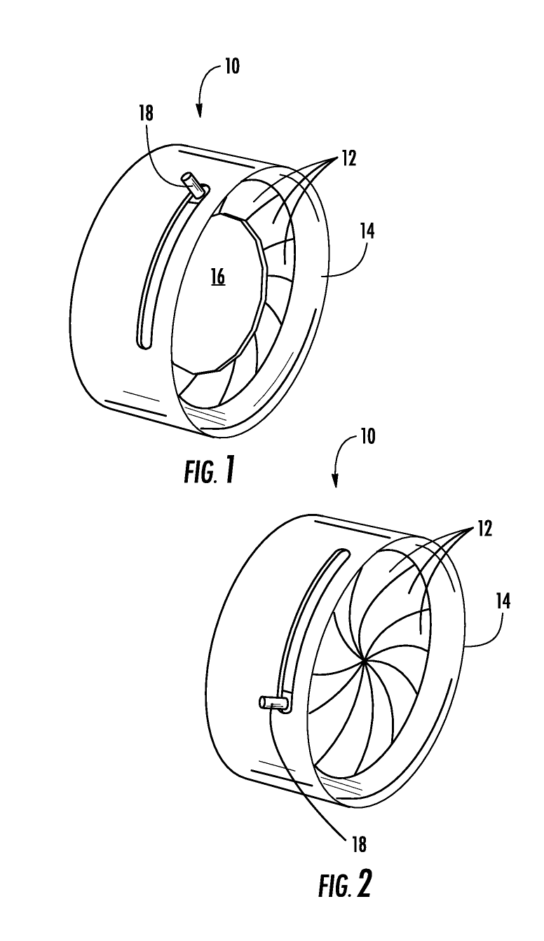

Now referring to the drawings, the aperture mechanism of the present invention is shown and generally illustrated in the figures at 10. Turning to FIGS. 1 and 2, the aperture mechanism 10 can be seen to generally include a plurality of aperture blades 12. A support frame 14 is provided that includes a central opening 16 therein. The support frame 14 is configured to receive and support the aperture blades 12 in a manner that allows movement of the aperture blades 12 within the support frame 14 as will be described below. Further, an actuator 18 is provided adjacent the support frame 14 and is operable to selectively move the aperture blades 12 between retracted position as is shown in FIG. 1 and an extended position as is shown in FIG. 2.

As was stated above, the general structure of the aperture mechanism 10 of the present invention is constructed to operate in the same fashion as any of the well-known iris type aperture controls disclosed in the prior art. A plurality of aperture blades 12 is attached into the support structure 14 in a manner that allows the aperture blades 12 to be selectively displaced by extending or retracting the aperture blades 12, which in turn causes the central aperture that is formed by the inner edges of the aperture blades 12 to open and close. Movement of the actuator 18 causes the aperture blades 12 to open or close thereby controlling the size of the aperture formed by the aperture blades 12. In order to actuate the aperture blades 12, the outer structure 14 of the aperture mechanism 10 is generally formed to include two coaxial disks facing with each other such that the aperture blades 12 are interposed therebetween. While the details of this operation are not particularly relevant to this invention one example is described wherein the first disk pivotably supports each of the aperture blades 12 at one end. The second disk is a cam disk having cam grooves for displacing the opposite ends of each of the aperture blades 12. Each aperture blade 12 is provided with a pin that engages a respective cam groove on the second disk. By rotating the first disk with respect to the second disk, the aperture blades 12 are moved in a manner that closes or opens the aperture. An actuator 18 is provided that engages the second disk allowing a user to turn the second disk relative to the first disk.

The principal point of novelty of the present invention lies in the fact that rather than forming the aperture blades 12 from an opaque material, the aperture blades 12 are formed of a material that is at least partially light transmissive. This is a distinct departure from the teachings in the prior art. Specifically, in the prior art, the aperture blades 12 were formed to be fully opaque and often coated with a non-reflective material. The reason for this is that the prior art aperture blades shaped the beam by obstructing the passage of light. In contrast, the entire goal of the present invention is to shape an output beam of light by allowing it to pass through the material from which the aperture blades 12 are formed.

In this regard, it is preferable that the aperture blades 12 are formed from a non-opaque or at least partially light transmissive polymer material. It is more preferable that the aperture blades 12 be formed form a polymer material that has light filtering properties. The filtering properties of the aperture blades 12 may include but is not limited to neutral density filters, general diffusion filters, patterned diffusion filters, colored filters, polarizing filters and diffraction screens. It is also possible that the strength of the filtering effect be varied along the length of the aperture blade 12. For example, the filtering effect on the aperture blade 12 may have a gradient diffusion material that decreases in strength along the length of said aperture blade 12 such that when the aperture mechanism 10 is fully closed, the ends of the aperture blades 12 near the center of the aperture mechanism 10 have a low diffusion quality while the ends of the aperture blades 12 near the support frame 14 have a stronger diffusion quality.

As can be seen in FIG. 3, the aperture mechanism 10 of the present invention is positioned at the output end of a flashlight 20 adjacent the point where the light beam 22 exits the flashlight 20. Actuation of the aperture mechanism 10 is accomplished by rotating an actuator disk 18 positioned concentrically around the support structure 14 of the aperture mechanism 10 that in turn causes the two rings of the aperture mechanism 10 to rotate relative to one another thereby causing the aperture blades 12 to open or close relative to one another. The light beam 22 passes through the blades 12 of the aperture mechanism 10 and is modified by whatever filter material that the aperture blades 12 are formed from.

Turning to FIG. 6, a cross sectional view of the flashlight 20 in FIG. 3 is shown. The flashlight 20 can be seen to generally include a power source 24, shown as batteries, enclosed within a housing 26 and a light source 28 in operative engagement with the power source 26. As was stated above, the light source 28 can be any type light source 28 suitable for use in a flashlight 20 including but not limited to incandescent, halogen, xenon, HID, LED and high output LED. Light output from the light source 28 is directed out one end of the housing 26. The light output beam 22 may leave the housing 26 directly or it may be shaped by a reflector 30 or a lens (not shown) before it exits the housing 26. As can be seen, the aperture mechanism 10 is positioned adjacent the output end of the housing 26 directly in the path of the light output beam 22. In FIG. 6, the aperture blades 12 can be seen in a retracted position while in FIG. 6a, the aperture blades 12 can be seen in a fully extended position.

In this particular illustration, the aperture blades 12 are shown as a diffusion screen material. In this manner, the aperture blades 12 are formed from a transparent polymer material having a diffusion screen on the surface thereof. The diffusion screen may be of any strength known in the art. When the actuator 18 is moved such that the aperture blades 12 are in the fully open position, as is shown in FIG. 6, the flashlight 20 functions normally, meaning that there is no change in the output beam 22 characteristics. Alternately, when the actuator 18 is moved so that the aperture blades 12 are in the fully closed position, as is shown in FIG. 6a, the entire output beam 22 passes through the diffusion screen thereby changing the beam angle by causing the output beam 22 to become more diffuse. For example if the diffusion screen provided a uniform 40° diffusion pattern, the output beam 22 would have a beam distribution that was 40° wider than the original output beam 22. It should also be appreciated that the actuator 18 can be positioned at any point such that the aperture blades 12 can be fully open, fully closed or any point therebetween. In this manner, the device provides an apparent zoom feature to the flashlight beam in that as the actuator 18 is turned, the aperture blades 12 cover more of the output beam 22 thereby diffusing more of the light output causing the far field beam to gradually change from a tight spot to a wide flood.

It should also be appreciated that while a 40° diffusion screen is disclosed in the example above, any variety of diffusion screens may be employed. Further, the diffusion screen may be graduated or patterned to form vertical or horizontal fan shaped beams to control the beam for other applications such as wall washing. Similarly, shaped diffusion screens such as starbursts may be employed.

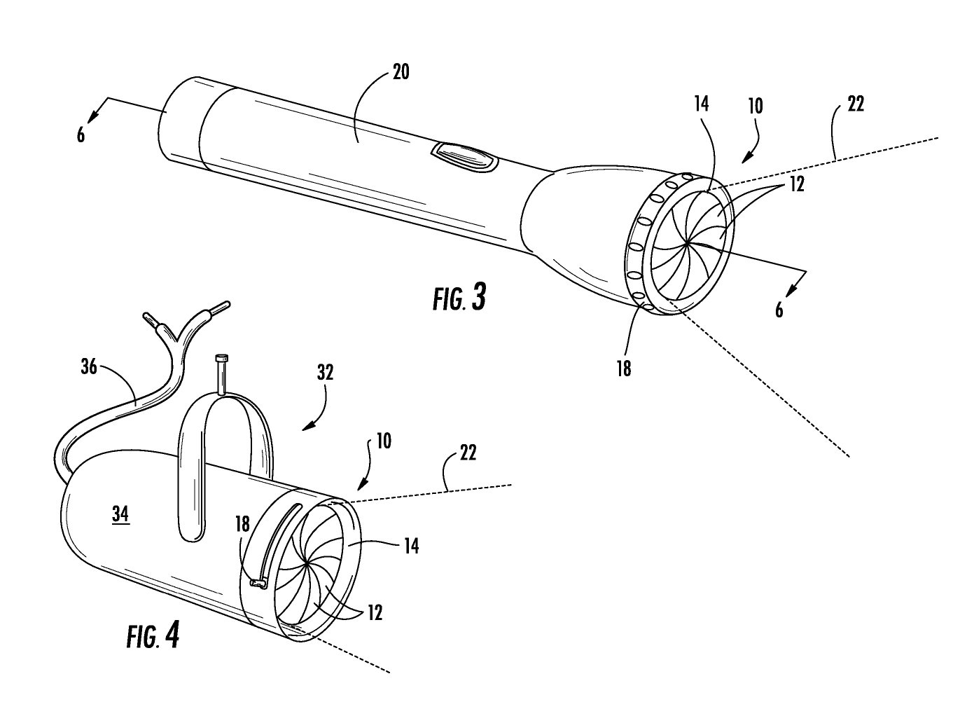

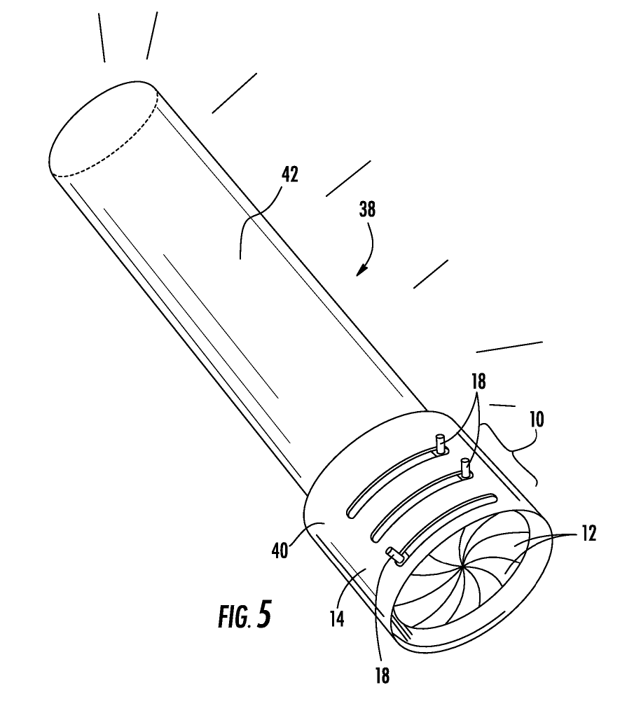

FIG. 4 depicts the aperture mechanism 10 of the present invention positioned at the output end of an architectural lighting fixture 32. The actuator 18 can be seen as a lever on the side of the support structure 14. Further, the aperture blades 12 can be seen in a partially closed position wherein the aperture blades 12 extend over an outer edge of the output end of the lighting fixture 32. The architectural fixture includes a housing 34 that supports the light source which may be any type of suitable light source such as incandescent, compact fluorescent, xenon, halogen, high intensity discharge (HID), and high brightness light emitting diodes (LEDs). The housing 34 also supports the aperture mechanism 10 in operative relation with the light source. In addition, a means for attaching a power supply 36 to the fixture 32 is provided thereby allowing the light to be energized.

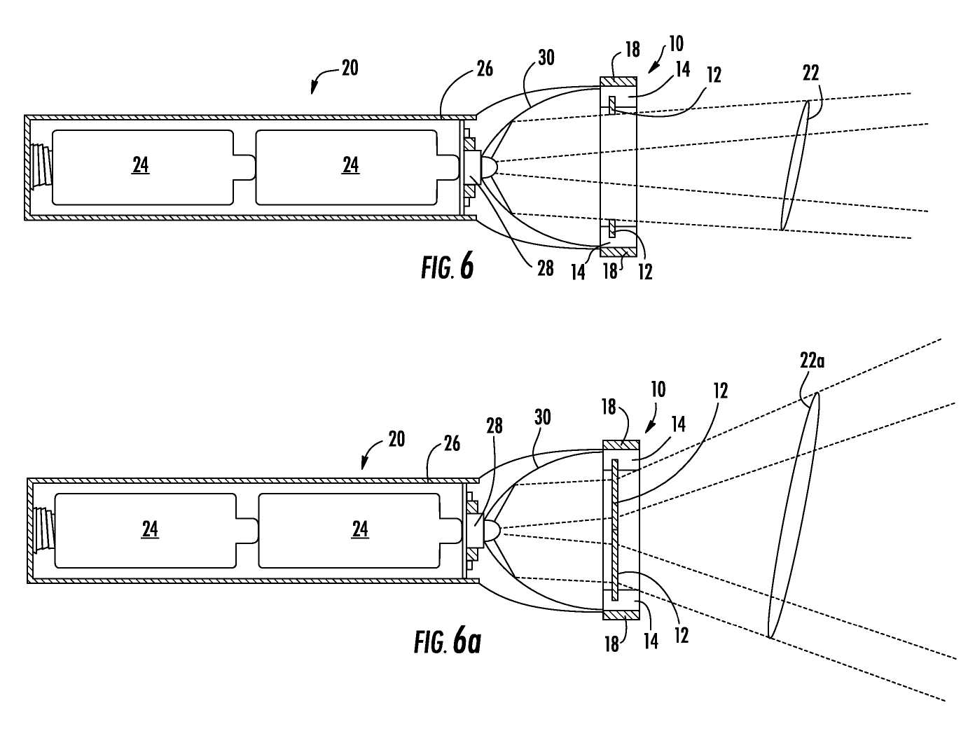

The present invention also anticipates that the aperture blades 12 may also be formed as a color filter. In this manner, the aperture blades 12 could be formed to allow a lighting device to be changed from white to any desired color by simply rotating the actuator 18. As an example, the aperture blades 12 may be red to allow a user to change a flashlight from white to a night vision friendly red. Similarly a light tube 38 is illustrated at FIG. 5 and is formed from a translucent tube 42 with a base 40 that contains several aperture mechanisms 10 having a variety of colored aperture blades 12 therein. For example the three aperture mechanisms 10 shown may have red, yellow and blue aperture blades 12 therein. Police often use flashlights in conjunction with such light cones 38 or tubes for directing traffic. In this case, the light tube accessory 38 can be formed such that the translucent tube 42 is white and a plurality of different colored aperture assemblies 10 can be positioned at the interface base 40 thereof. By closing the desired aperture mechanism 10 thereby extending the colored aperture blades 12 contained therein across the light beam, the color of the tube 42 can be easily changed to any of the available filter colors, eliminating the need to have several different cones of differing colors.

In this manner it can be seen that the present invention provides a novel construction for an aperture mechanism 10 that can provide a user with a broad variety of options for controlling, shaping and coloring an output beam 22 of light in a manner that was previously unknown in the art. In addition, the aperture assembly 10 of the present invention provides a broad range of flexibility and adjustability of an output light beam 22 while allowing its incorporation in a variety of configurations. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. An aperture mechanism for variably adjusting an output light beam, said aperture mechanism comprising:
a plurality of aperture blades;
a support frame having an opening therein, said support frame configured to receive and support said plurality of aperture blades, wherein said aperture blades are movable within said support frame between a retracted position and an extended position wherein said aperture blades extend across said opening; and
an actuator adjacent said support frame, said actuator operable to selectively move said plurality of aperture blades between said retracted and extended positions,
wherein said aperture blades are at least partially light transmissive.

2. The aperture mechanism of claim 1, wherein said aperture blades are formed from a polymer material.

3. The aperture mechanism of claim 2, wherein said polymer material is a light filtering material.

4. The aperture mechanism of claim 3, wherein said light filtering material is of a type selected from the group consisting of: neutral density, general diffusion, patterned diffusion, colored, polarizing and diffraction.

5. The aperture mechanism of claim 3, wherein the filtering material is a gradient filtering material that decreases in strength along the length of said aperture blade.

6. The aperture mechanism of claim 3, wherein said aperture blades are a diffusion screen material wherein said output beam has a narrow beam angle when said aperture blades are retracted, said beam angle becoming increasingly wider as said aperture blades are extended.

7. The aperture mechanism of claim 1, wherein said actuator is selectively rotatable relative to said support frame between a fully open position wherein said plurality of aperture blades are retracted and a fully closed position wherein said aperture blades are fully extended.

8. The aperture mechanism of claim 1, wherein said aperture mechanism is positioned adjacent the output beam of a flashlight.

9. The aperture mechanism of claim 1, wherein said aperture mechanism is positioned adjacent the output beam of an architectural lighting fixture.

10. The aperture mechanism of claim 4, wherein said aperture blades are colored and at least one aperture mechanism is positioned at the input end of a translucent light tube, such that a light output beam entering said translucent light tube is colored by said colored aperture.

11. A lighting assembly with an adjustable output beam comprising:
a light source, said light source generating an output beam; and
an aperture mechanism disposed in operative engagement with said light source for variably adjusting said output light beam, said aperture mechanism including:
a plurality of aperture blades,
a support frame having an opening therein, said support frame configured to receive and support said plurality of aperture blades, wherein said aperture blades are movable within said support frame between a retracted position and an extended position wherein said aperture blades extend across said opening, and
an actuator adjacent said support frame, said actuator operable to selectively move said plurality of aperture blades between said retracted and extended positions,
wherein said aperture blades are at least partially light transmissive.

12. The lighting assembly of claim 11, wherein said lighting assembly is a flashlight further comprising:
a power source in operative engagement with said light source; and
a housing containing said power source and said light source wherein said output beam is directed outwardly from a first end of said housing, said aperture mechanism disposed adjacent said first end of said housing.

13. The lighting assembly of claim 11, wherein said lighting assembly is an architectural lighting fixture further comprising:
a housing containing said light source wherein said output beam is directed outwardly from a first end of said housing, said aperture mechanism disposed adjacent said first end of said housing; and
means for connecting said lighting assembly to a remote power source.

14. The lighting assembly of claim 11, wherein said light source is selected from the group consisting of: incandescent, compact fluorescent, xenon, halogen, high intensity discharge (HID), and high brightness light emitting diodes (LEDs).

15. The lighting assembly of claim 11, wherein said aperture blades are formed from a polymer material.

16. The lighting assembly of claim 15, wherein said polymer material is a light filtering material.

17. The lighting assembly of claim 16, wherein said light filtering material is of a type selected from the group consisting of: neutral density, general diffusion, patterned diffusion, colored, polarizing and diffraction.

18. The lighting assembly of claim 16, wherein the filtering material is a gradient filtering material that decreases in strength along the length of said aperture blade.

19. The lighting assembly of claim 16, wherein said aperture blades are a diffusion screen material wherein said output beam has a narrow beam angle when said aperture blades are retracted, said beam angle becoming increasingly wider as said aperture blades are extended.

20. A flashlight comprising:
a housing having a first end;
a power source disposed within said housing;
a light source disposed within said housing in operative engagement with said power source, said light source generating an output beam wherein said output beam is directed outwardly from said first end of said housing; and
an aperture mechanism disposed adjacent said first end of said housing for variably adjusting said output light beam, said aperture mechanism including:
a plurality of aperture blades,
a support frame having an opening therein, said support frame configured to receive and support said plurality of aperture blades, wherein said aperture blades are movable within said support frame between a retracted position and an extended position wherein said aperture blades extend across said opening, and
an actuator adjacent said support frame, said actuator operable to selectively move said plurality of aperture blades between said retracted and extended positions,
wherein said aperture blades are at least partially light transmissive.

21. The flashlight of claim 20, wherein said aperture blades are formed of a light filtering material of a type selected from the group consisting of: neutral density, general diffusion, patterned diffusion, colored, polarizing and diffraction.

22. The flashlight of claim 20, wherein said aperture blades are a diffusion screen material wherein said output beam has a narrow beam angle when said aperture blades are retracted, said beam angle becoming increasingly wider as said aperture blades are extended.

23. The flashlight of claim 20, wherein said actuator is a concentric ring positioned around an outer surface of said aperture mechanism.
